(19) United States
(12) Patent Application Publication
(10) Pub. No.: US 2007/0074236 A1
(43) Pub. Date: Mar. 29, 2007

(54) OPTICAL DISK DRIVE AND ASSEMBLY METHOD FOR ASSEMBLING STEPPING MOTOR ON TRAVERSE THEREOF

(76) Inventors: Chun-Lung Ho, Taipei City (TW); Yi-Cheng Tsao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,163

(22) Filed: Dec. 19, 2005

(30) Foreign Application Priority Data
Sep. 26, 2005 (TW) 94133319

(51) Int. Cl. G11B 7/00

(52) U.S. Cl. 720/673

(57) ABSTRACT

A traverse including a stepping motor, a supporting base, a spindle motor module and an optical pick-up head module is provided. The stepping motor has at least a first alignment hole, and the supporting base is suitable for carrying the stepping motor and the spindle motor module. The supporting base has an opening and at least a hollow alignment boss, wherein the hollow alignment boss is disposed through the first alignment hole of the stepping motor. In addition, the external diameter of the top of the hollow alignment boss is greater than the diameter of the first alignment hole. The optical pick-up head module is connected with the stepping motor. The stepping motor is suitable for enabling the optical pick-up head module moving inside the opening. Besides, an optical disk drive applying the above traverse and a assembly method of the above stepping motor and supporting base are also proposed.

### CROSS-REFERENCE TO RELATED APPLICATION

This application claims the priority benefit of Taiwan application serial no. 94133319, filed on Sep. 26, 2005. All disclosure of the Taiwan application is incorporated herein by reference.

### BACKGROUND OF THE INVENTION

1. Field of Invention

The present invention relates to an optical disk drive. More particularly, the present invention relates to an assembly method for assembling a stepping motor on a traverse in an optical disk drive.

2. Description of Related Art

With the progress of the modern storage techniques, the optical disk has the advantages of mass storage capacity, easy preservation, long storage time, low cost, and data durability and the like; and the users can read data stored in the optical disk easily with the optical disk drive, therefore, the combination of optical disk drive and optical disk has replaced the conventional magnetic storage medium and becomes one of the indispensable storage media. Furthermore, due to the fierce competition of the optical disk drive market, manufacturers of the optical disk drive are devoted to reducing the production cost and improving the competitiveness.

FIGS. 1A and 1B respectively depict the three-dimensional schematic view of a conventional traverse from bottom and top views. Referring to FIGS. 1A and 1B, the conventional traverse 100 used in an optical disk drive includes a stepping motor 110, a supporting base 120, a spindle motor module 130 and an optical pick-up head module 140. The supporting base 120 has an opening 122 and is suitable for supporting the stepping motor 110 and the spindle motor module 130. The spindle motor module 130 is suitable for supporting an optical disk (not shown) and rotating the optical disk at a high speed. The stepping motor 110 is connected with the optical pick-up head module 140 so that the optical pick-up head module 140 is able to move inside the opening 122 to read the data in the above described optical disk.

As described, in the conventional technique, the stepping motor 110 is commonly fixed on the supporting base 120 by two screws 150. However, the assembly of this technique takes a lot of time in tightening the screws 150, and the screws may be stripped easily. Thus, a lot of working hours are wasted; the cost of assembling the traverse 100 becomes expensive; and the competitiveness of the optical disk drive cannot be improved effectively.

### SUMMARY OF THE INVENTION

In view of the above, the object of the present invention is to provide a traverse which reduces the production cost.

Another object of the present invention is to provide an optical disk drive having the above traverse, thus reducing the production cost.

Still another object of the present invention is to provide a method for assembling a stepping motor on a supporting base so as to reduce the assembly time.

For the above and other purposes, a traverse is provided in the present invention, which includes a stepping motor, a supporting base, a spindle motor module and an optical pick-up head module. The stepping motor has at least one first alignment hole, and the supporting base is suitable for supporting the stepping motor. The supporting base has an opening and at least one hollow alignment boss, wherein the hollow alignment boss is disposed through the first alignment hole of the stepping motor and the external diameter of the top of the hollow alignment boss is larger than the diameter of the first alignment hole. The spindle motor module is disposed on the supporting base. The optical pick-up head module is connected with the stepping motor. In addition, the stepping motor is suitable for enabling the optical pick-up head module moving inside the opening.

In an embodiment of the present invention, the traverse further includes, for example, a locking means. The stepping motor further includes, for example, a second alignment hole. Further, the supporting base further includes, for example, a third alignment hole corresponding to the second alignment hole, wherein the locking means is disposed through the second alignment hole and the third alignment hole. Furthermore, the locking means is, for example, a screw.

For the above and other purposes, an optical disk drive is further provided in the present invention, which includes a housing and a traverse disposed in the housing. The traverse includes a stepping motor, a supporting base, a spindle motor module and an optical pick-up head module. The stepping motor has at least one first alignment hole, and the supporting base is suitable for supporting the stepping motor. The supporting base has an opening and at least one hollow alignment boss, wherein the hollow alignment boss is disposed through the first alignment hole of the stepping motor and the external diameter of the top of the hollow alignment boss is larger than the diameter of the first alignment hole. The spindle motor module is disposed on the supporting base. The optical pick-up head module is connected with the stepping motor, and the stepping motor is suitable for enabling the optical pick-up head module moving inside the opening.

In an embodiment of the present invention, the traverse further includes, for example, a locking means. The stepping motor further includes, for example, a second alignment hole. And the supporting base further includes, for example, a third alignment hole corresponding to the second alignment hole. Wherein, the locking means is disposed through the second alignment hole and the third alignment hole. Furthermore, the locking means includes, for example, a screw.

In an embodiment of the present invention, the optical disk drive further includes, for example, a tray disposed in the housing and suitable for being ejected from the housing.

For the above or other purposes, a method for assembling a stepping motor on a supporting base of a chassis used in an optical disk drive is further provided in the present invention. Wherein, the supporting base has at least one hollow alignment boss, and the stepping motor has at least one first alignment hole. The method for assembling the stepping motor on the supporting base includes the following steps: first, placing the stepping motor on the supporting base and nesting the first alignment hole on the hollow alignment boss; punching the hollow alignment boss such that the external diameter of the top of the hollow alignment boss is larger than the diameter of the first alignment hole.

In an embodiment of the present invention, the stepping motor further includes, for example, a second alignment hole, and the supporting base further includes, for example, a third alignment hole corresponding to the second alignment hole. A locking means, for example, is further locked into the second alignment hole and the third alignment hole after the step of punching the hollow alignment boss.

In view of the above, the present invention mainly disposes the hollow alignment boss of the supporting base through the first alignment hole of the stepping motor, and punches the hollow alignment boss such that the external diameter of the top of the hollow alignment boss is larger than the diameter of the first alignment hole, thereby positioning and fixing the stepping motor on the supporting base. Thus, not only the working hours of tightening the screws are reduced, but also the screw being stripped is avoided, thereby reducing the assembling time of the traverse and lowering the production cost.

In order to the make the aforementioned and other objects, features and advantages of the present invention apparent, the preferred embodiments in accompany with drawings are described in detail below.

### BRIEF DESCRIPTION OF THE DRAWINGS

FIGS. 1A and 1B depict the three-dimensional schematic view of a conventional traverse from bottom and top views respectively.

FIG. 2 depicts a partially exploded schematic view of a traverse according to an embodiment of the present invention.

FIG. 3A depicts a partial side view of the stepping motor before being fixed on the supporting base.

FIG. 3B depicts a partial side view of the stepping motor fixed on the supporting base.

FIG. 4 depicts the partial schematic view of the stepping motor and the supporting base of FIG. 2 after being assembled.

FIGS. 5A and 5B depict the schematic view of a traverse according to another embodiment of the present invention before and after assembly respectively.

FIG. 6 depicts an exploded three-dimensional schematic view of an optical disk drive according to an embodiment of the present invention.

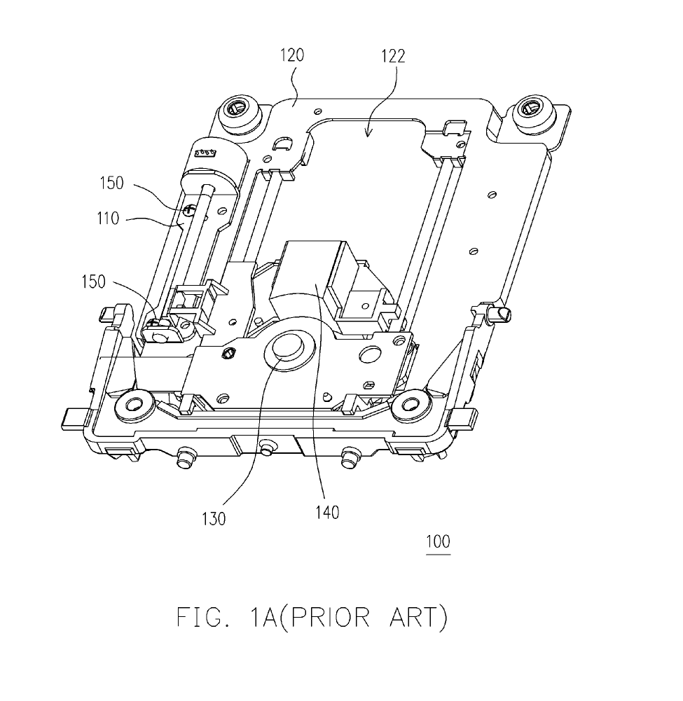

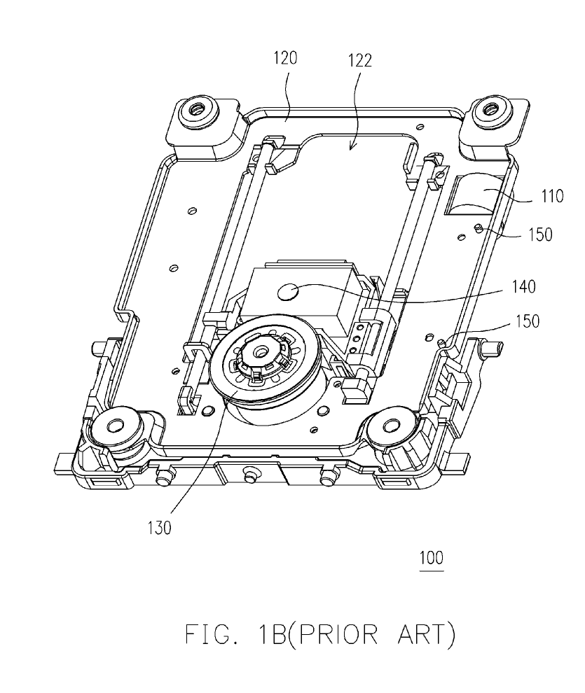

### DESCRIPTION OF EMBODIMENTS

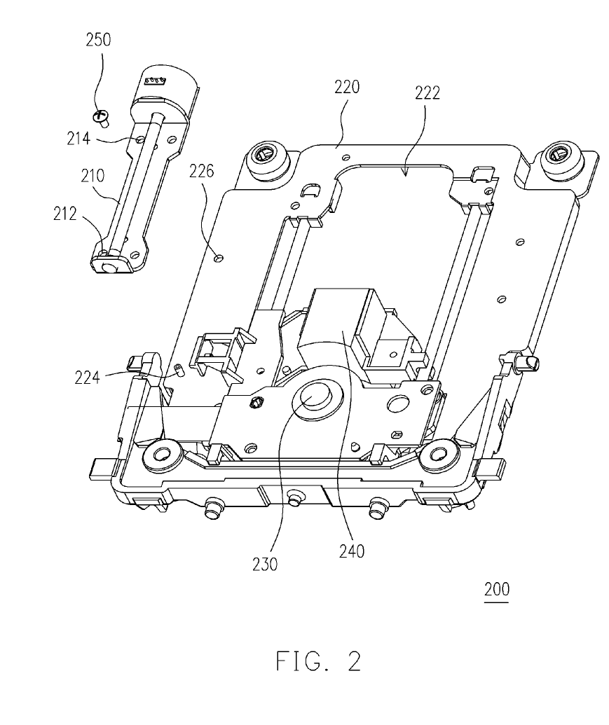

FIG. 2 depicts a partially exploded schematic view of a traverse according to an embodiment of the present invention. Referring to FIG. 2, the traverse 200 used in an optical disk drive of the present embodiment mainly includes a stepping motor 210, a supporting base 220, a spindle motor module 230 and an optical pick-up head module 240. The supporting base 220 has an opening 222 and a hollow alignment boss 224 thereon. The stepping motor 210 has a first alignment hole 212 corresponding to the hollow alignment boss 224, wherein the hollow alignment boss 224 can be disposed through the first alignment hole 212. Furthermore, the supporting base 220 is suitable for supporting the spindle motor module 230, and the spindle motor module 230 is suitable for supporting an optical disk (not shown) and rotating the optical disk at a high speed. The stepping motor 210 is connected with the optical pick-up head module 240 and suitable for moving the optical pick-up head module 240 inside the opening 222 of the supporting base 220 to read data in the aforementioned optical disk.

In the present embodiment, the formation of the hollow alignment boss 224 of the supporting base 220 is, for example, extruding the hollow alignment boss 224 directly from the supporting base 220 by the plastic extrusion forming technique, that is, the supporting base 220 and the hollow alignment boss 224 are integrated as a whole. Furthermore, the traverse 200 further includes, for example, a locking means 250, such as a screw. Definitely, the locking means can be a bolt or other suitable locking means. Moreover, the stepping motor 210 further includes, for example, a second alignment hole 214, and the supporting base 220 further includes a third alignment hole 226 corresponding to the second alignment hole 214.

The assembly process of the stepping motor 210 and the supporting base 220 of the traverse 200 in the present invention will be described hereinafter in combination of the accompanying drawings.

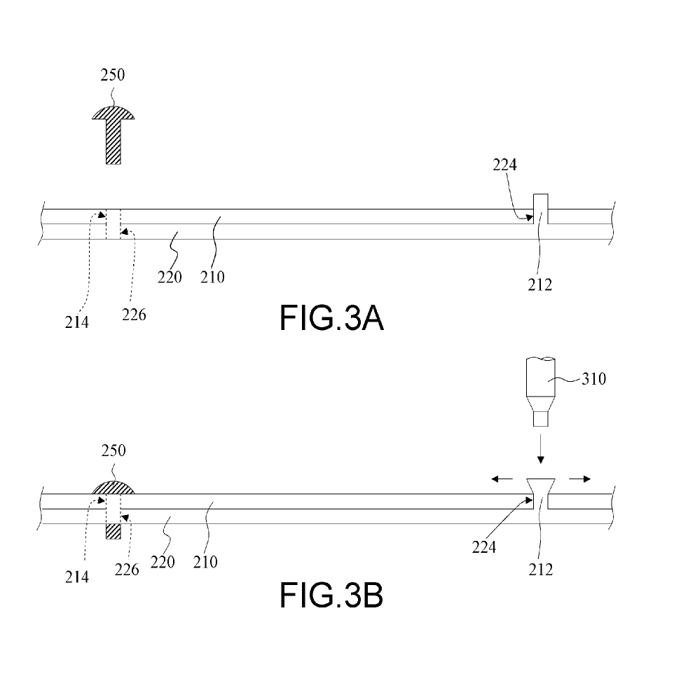

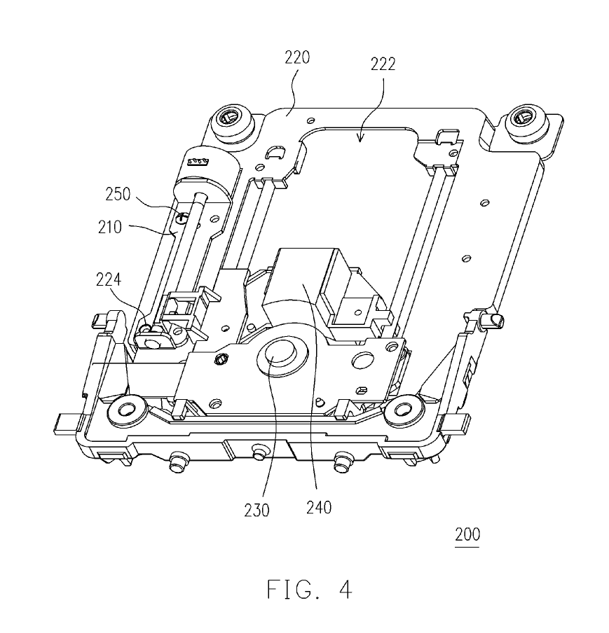

FIG. 3A depicts a partial side view of the stepping motor before being fixed on the supporting base, and FIG. 3B depicts a partial side view of the stepping motor fixed on the supporting base. The method for assembling the stepping motor 210 on the supporting base 220 of the present embodiment mainly includes the following steps. First, referring to FIG. 3A, placing the stepping motor 210 on the supporting base 220 and nesting the first alignment hole 212 of the stepping motor 210 on the hollow alignment boss 224 of the supporting base 220, such that the stepping motor 210 is positioned on the supporting base 220.

Next, referring to FIG. 3B, a punching tool 310 is used to punch the hollow alignment boss 224 downwards, such that the top thereof is deformed outward and expanded the hole. The external diameter of the top of the deformed hollow alignment boss 224 is larger than the diameter of the first alignment hole 212, and the stepping motor 210 can thus be fixed on the supporting base 220 by the hollow alignment boss 224. Obviously, the present invention is not limited to the way of deforming the top of the hollow alignment boss 224 by expanding the hole.

As described, referring back to FIGS. 3A and 3B, after punching the hollow alignment boss 224 to fix the stepping motor 210 on the supporting base 220, the locking means 250 is screwed into the second alignment hole 214 and the third alignment hole 226 to complete the assembly of the traverse 200. Although the aforementioned method for assembling the stepping motor 210 on the supporting base 220 includes that employing the locking means 250 to lock the stepping motor 210 on the supporting base 220 after punching the hollow alignment boss 224. However, in the present invention the stepping motor 210 and the supporting base 220 can also be locked by the locking means 250 first before the hollow alignment boss 224 is punched.

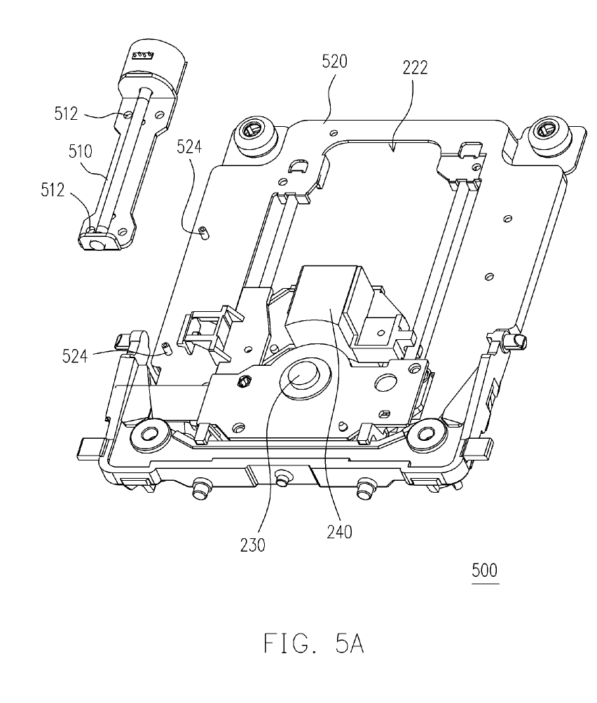

FIG. 4 depicts the partial schematic view of the stepping motor and the supporting base of FIG. 2 after being assembled. Referring to FIG. 4, the stepping motor 210 of the present embodiment is fixed on the supporting base 220 by the deformed hollow alignment boss 224. Since the spending time of punching is less than that of screwing, the assembly time can be shortened and the manpower cost is thus reduced. Accordingly, the competitiveness of the product price can be upgraded. Furthermore, compared with the conventional technique of using two screws to fix the stepping motor on the supporting base, the traverse 200 of the present embodiment can reduce the use of the locking means 250 in assembly. Therefore, the material cost of the locking means 250 can be reduced significantly in mass production.

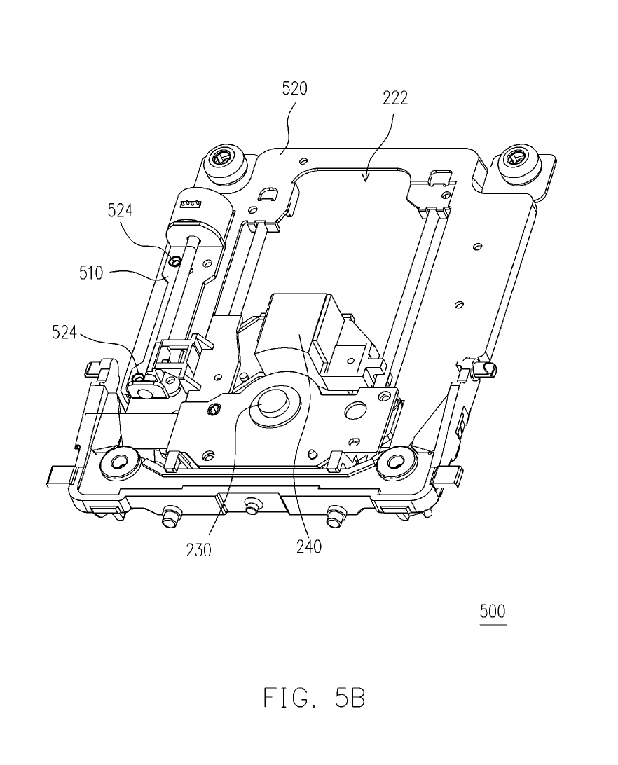

FIGS. 5A and 5B depict the schematic view of a traverse according to another embodiment of the present invention before and after assembly, respectively. Referring to FIGS. 5A and 5B, the traverse 500 of the present embodiment is similar to the traverse 200 of the aforementioned embodiment (as shown in FIG. 2), except that the supporting base 520 of the traverse 500 of the present embodiment has two hollow alignment bosses 524, and the stepping motor 510 has two first alignment holes 512 corresponding to the hollow alignment bosses 524. In other words, in the traverse 500, the stepping motor 510 is fixed on the supporting base 520 by two hollow alignment bosses 524, while in the traverse 200, the stepping motor 210 is fixed on the supporting base 220 by a hollow alignment boss 224 and a locking means 250.

In particular, the method of assembling the stepping motor 510 on the supporting base 520 of the present embodiment mainly includes nesting the two first alignment holes 512 of the stepping motor 510 on the two hollow alignment bosses 524 of the supporting base 520, then punching the two hollow alignment bosses 524 to fix the stepping motor 510 on the supporting base 520 (as shown in FIG. 5B).

The locking means 250 (as shown in FIG. 3A) is not used in the assembly process of the stepping motor 510 and the supporting base 520, therefore, not only the material cost of the locking means is saved, but the problem of screw being stripped can also be avoided, thereby improving the assembly efficiency so as to achieve the object of reducing the production cost of the traverse 500.

It should be noted that the present invention is not limited in the number of the hollow alignment bosses, i.e. more than two hollow alignment bosses can be disposed on the supporting base of the traverse. Moreover, in the present invention, the hollow alignment boss can also be disposed on the stepping motor of the traverse, and the alignment hole can also be disposed on the supporting base corresponding to the hollow alignment boss. The aforementioned circumstance can be known by those skilled in the art, and is not illustrated with drawings.

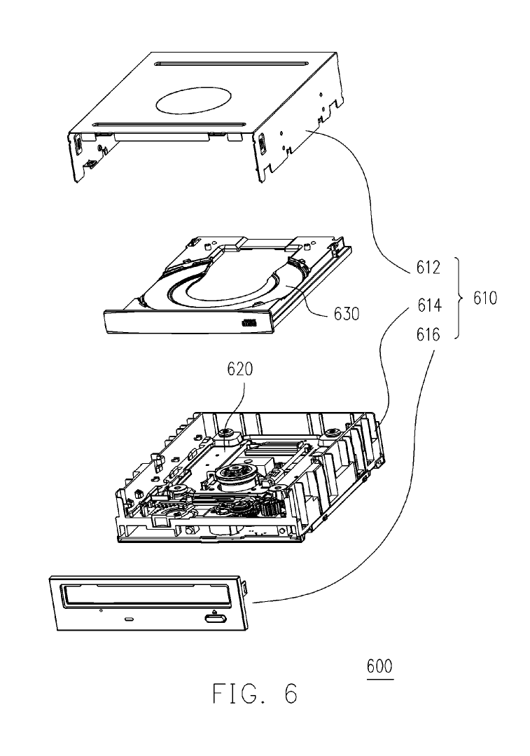

FIG. 6 depicts an exploded three-dimensional schematic view of an optical disk drive according to an embodiment of the present invention. Referring to FIG. 6, the optical disk drive 600 of the present embodiment mainly includes a housing 610 and a traverse 620, wherein the traverse 620 can be various traverse (e.g. traverses 200, 500) in the aforementioned embodiments. The housing 610 is consisted of, for example, an upper housing 612, a bottom housing 614 and a panel 616; and the traverse 620 is disposed in the housing 610. Furthermore, the optical disk drive 600 further includes, for example, a tray 630 disposed in the housing 610 and is suitable for being ejected from the housing 610 through the opening of the panel 616 to support an optical disk (not shown).

Since the optical disk drive 600 of the present embodiment has the traverse 620 of lower production cost, it is competitive in price.

In view of the above, the optical disk drive and the method of assembling stepping motor on supporting base of the present invention at least have the following advantages:

It requires less working hours to fix the stepping motor on the supporting base by punching the hollow alignment boss, thus improving the assembly efficiency of the stepping motor and supporting base and further reducing the production cost of the traverse.

The amount of the locking means is reduced or even omitted in the present invention, thus saving the material cost of the locking means.

Since the production cost of the traverse of the present invention is low, the optical disk drive with this traverse is competitive in the market.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A traverse, comprising:
a stepping motor having at least one first alignment hole;
a supporting base suitable for supporting the stepping motor and having a opening and at least one hollow alignment boss, wherein the hollow alignment boss is disposed through the first alignment hole of the stepping motor, and the external diameter of the top of the hollow alignment boss is larger than the diameter of the first alignment hole;
a spindle motor module disposed on the supporting base; and
an optical pick-up head module connected with the stepping motor, and the stepping motor being suitable for enabling the optical pick-up head module moving inside the opening.

2. The traverse as claimed in claim 1, further comprising a locking means, and the stepping motor further having a second alignment hole, the supporting base further having a third alignment hole corresponding to the second alignment hole, and the locking means being disposed through the second alignment hole and the third alignment hole.

3. The traverse as claimed in claim 2, wherein the locking means includes a screws.

4. An optical disk drive, comprising:
a housing;
a traverse disposed in the housing, the traverse comprising:
a stepping motor having at least one first alignment hole;
a supporting base suitable for supporting the stepping motor and having an opening and at least one hollow alignment boss, wherein the hollow alignment boss is disposed through the first alignment hole of the stepping motor, and the external diameter of the top of the hollow alignment boss is larger than the diameter of the first alignment hole;
a spindle motor module disposed on the supporting base; and
a pick-up head module connected with the stepping motor, and the stepping motor being suitable for enabling the optical pick-up head module moving inside the opening.

5. The optical disk drive as claimed in claim 4, wherein the traverse further comprises a locking means, the stepping motor further has a second alignment hole, the supporting base further has a third alignment hole corresponding to the second alignment hole, and the locking means is disposed through the second alignment hole and the third alignment hole.

6. The optical disk drive as claimed in claim 5, wherein the locking means includes a screw.

7. The optical disk drive as claimed in claim 4, further comprising a tray disposed in the housing, the tray being suitable for being ejected from the housing.

8. A method for assembling a stepping motor on a supporting base of a traverse used in an optical disk drive, wherein the supporting base has at least one hollow alignment boss, and the stepping motor has at least one first alignment hole, the method for assembling the stepping motor on the supporting base comprising:
placing the stepping motor on the supporting base, and nesting the first alignment hole on the hollow alignment boss; and
punching the hollow alignment boss so as to form the external diameter of the top of the hollow alignment boss larger than the diameter of the first alignment hole.

9. The method for assembling the stepping motor on the supporting base as claimed in claim 8, wherein the stepping motor further has a second alignment hole, the supporting base further has a third alignment hole corresponding to the second alignment hole, and the method further comprising locking a locking means into the second alignment hole and the third alignment hole after punching the hollow alignment boss.
